(19) United States
(12) Patent Application Publication
(10) Pub. No.: US 2026/0309526 A1
(43) Pub. Date: Oct. 8, 2026

(54) FLOW METER

(71) Applicant: Webtec Products Limited, St. Ives (GB)

(72) Inventors: Mark WARD, St Ives (GB); Graeme JOHNSON, St. Ives (GB)

(21) Appl. No.: 19/640,612

(22) Filed: Apr. 7, 2026

(30) Foreign Application Priority Data
Apr. 8, 2025 (GB) 250228.3

(51) Int. Cl. G01F 1/115

(52) U.S. Cl. CPC G01F 1/115

(57) ABSTRACT

An in-line fluid flow meter for measuring the flow rate and direction of fluid flowing in a line, comprising (a) a spindle, mounted onto which is (b) a rotatable rotor comprising at least three vanes or protrusions such that impingement thereon by a flowing fluid in the line causes rotation of the rotor around the spindle, (c) a detector, arranged to detect the presence of the vanes or protrusions as they pass a detecting position, during the rotation of the rotor on the spindle, wherein the angular spacing between two adjacent vanes or protrusions has a first angular spacing, the angular spacing between another two adjacent vanes or protrusions having a second spacing which is measurably different to the first spacing, and wherein the angular spacing between another two adjacent vanes or protrusions have a third spacing which is measurably different to both the first spacing and the second spacing.

### TECHNICAL FIELD

The present invention relates to in-line fluid flow meter for measuring the flow rate and direction of fluid flowing in a line.

### BACKGROUND AND PRIOR ART

In-line flow meters have been widely used for many years. They involve a central spindle, onto which is mounted a rotor, attached to which are a plurality of vanes or protrusions. The passage of fluid impinges on the vanes or protrusions and causes the rotor to rotate about the spindle. The rate of flow can be determined by being correlated to the rotation rate of the rotor, which can be directly measured.

Turbine flow meters have been a reliable and accurate meter technology to measure fluid flow in a pipe for many years. A turbine rotor is rotatably mounted within the pipe and the passing fluid rotates it in proportion to the flow rate. The direction of rotation of the rotor is determined by the direction of flow of the fluid along the pipe. If the fluid flow direction changes then so does the rotor direction.

Absolute fluid flow rate is therefore determined by measuring the rotation rate of the rotor. The rotation rate of the rotor is typically measured by determining the time difference between rotor blades passing an external sensor. For example, using a six bladed rotor with evenly spaced vanes the rotation rate can be measured for each of the six time periods of a single revolution, and averaging of these providing an accurate measurement of the rate of rotation of the whole rotor.

To also determine the sense of the rotation, the principle of phase quadrature has been used for many years. This involves the use of two sensors, typically positioned orthogonally to each other (or at least not opposite each other). A rotating element (which can be a turbine blade itself) then passes the two sensors in a particular order depending on the sense of the rotation. Thus, the order in which the sensors detect the signal determines the sense of the rotation.

A phase quadrature flow meter therefore requires two separate transducers mounted at differing positions around the circumference of the turbine so they create 90° out-of-phase signals. This adds cost and complexity to the sensor and requires two sensor transducers, which increases the cost.

When the direction of flow is not required, only one transducer can be employed, to keep the device simple and less expensive.

Further improvements in this area would therefore be useful.

### BRIEF DESCRIPTION OF THE INVENTION

The invention relates to an in-line fluid flow meter for measuring the flow rate and direction of fluid flowing in a line, comprising (a) a spindle, mounted onto which is (b) a rotatable rotor comprising at least three vanes or protrusions such that impingement thereon by a flowing fluid in the line causes rotation of the rotor around the spindle, (c) a detector, arranged to detect the presence of the vanes or protrusions as they pass a detecting position, during the rotation of the rotor on the spindle, wherein the angular spacing between two adjacent vanes or protrusions has a first angular spacing, the angular spacing between another two adjacent vanes or protrusions having a second spacing which is measurably different to the first spacing, and wherein the angular spacing between another two adjacent vanes or protrusions have a third spacing which is measurably different to both the first spacing and the second spacing.

As there are at least three measurably different spacings, this enables the order of the spacings measured in a single revolution of the rotor at the detecting position, to be used to determine the sense in which the rotor is rotating, which in turn provides a determination of the direction of the fluid flow.

The flow meter may be a turbine flow meter, a paddle wheel flow meter or a positive displacement flow meter. Preferably the meter is a turbine flow meter, where the vanes or protrusions are turbine blades, angled such that impingement thereon by passing fluid causes the rotor to rotate.

In the context of the present invention, the angular spacing is best measured as a separation angle, i.e. the angle of two adjacent vanes or protrusions around the spindle. Suitable angular spacings are all within the range of from 150° to 20°, preferably from 100° to 30°. For example, a three bladed turbine could be positioned around the spindle with spacings of 80°, 160° and 120°. However, a more balanced design having six blades could have two spacings of 40°, two spacings of 80° and two spacings of 60°.

However, for the purposes of balance, it is preferred that the difference between the maximum angular spacing and the minimum angular spacing is less than 40°, preferably less than 20°, more preferably less than 10°.

In general, two spacings are “measurably different” if they are more than 1°different, more than 2° different, preferably more than 5° different.

One convenient method of arranging the vanes or protrusions to adopt an arrangement according to the present invention is to start from a set of evenly spaced vanes or protrusions, and then move the position of one vane or protrusion. This has the effect of creating a larger spacing (e.g. a third spacing) and a smaller spacing (e.g. a second spacing), while the spacings between the other turbine blades remains unchanged (e.g. a first spacing).

One benefit of the present invention is that it can function to determine the flow rate as well as the direction of fluid flow with a single detector. Therefore, the flow meter preferably comprises a single detector and only one detecting position.

In order for the flow meter to operate with fluid flow in both directions, it may be necessary to ensure that the leading and trailing edges of the turbine blades are consistent with each other to provide an equal response to fluid flowing in either direction.

When the flow meter is a turbine flow meter it is preferred that the gap between each turbine blade and the detector, otherwise known as the clearance, is essentially the same for each blade, to ensure consistent measuring of the turbine blades presence. A turbine clearance (i.e. turbine tip to internal body diameter) of greater than 10% is preferred so that the flow meter is insensitive to turbulent profiles. A hub-to-turbine tip ratio (i.e. the ratio of the diameter of the circle passing through the turbine blade tips to the diameter of the circle surrounding the hub) of 0.5 to 0.6 is preferred.

The number of vanes or protrusions can be determined according to the physical requirements of the flow meter, however, preferably there are at least four vanes or protrusions, to provide rotational balance to the turbine rotor. When there are more than three turbine blades it is preferred that the additional angular spacings that are provided by the additional turbine blades are the same as the first, second and/or third angular spacings. This provides duplication in the measurable spacings and makes the sense signal clearer to recognize.

Preferably there are at least five vanes or protrusions, e.g. from five to ten turbine blades. However, an even number of vanes or protrusions can provide greater balance, such as six, eight or ten may be preferred.

In order for a highly balanced arrangement it is preferred that each vane or protrusion is positioned to have a directly opposing turbine blade, i.e. they are positioned 180° apart. For example, a blade arrangement where the angular spacings are two first angular spacings, two second angular spacings and two third angular spacings, requiring at least six turbine blades, is highly preferred.

In general a microcontroller is used to count the relative time between the pulses and then process to determine the direction by internal computation.

The vanes or protrusions are generally made from ferrous steel to operate with the magnetic reluctance transducer. Other materials and detection technologies can however be incorporated.

The invention will now be illustrated, by way of example, and with reference to the following figures, in which:

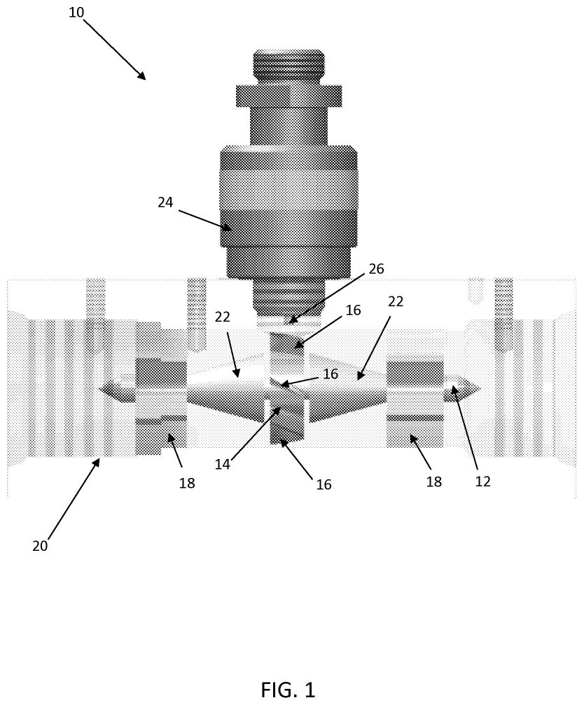

FIG. 1 is side view of a flow meter according to the present invention positioned within a line.

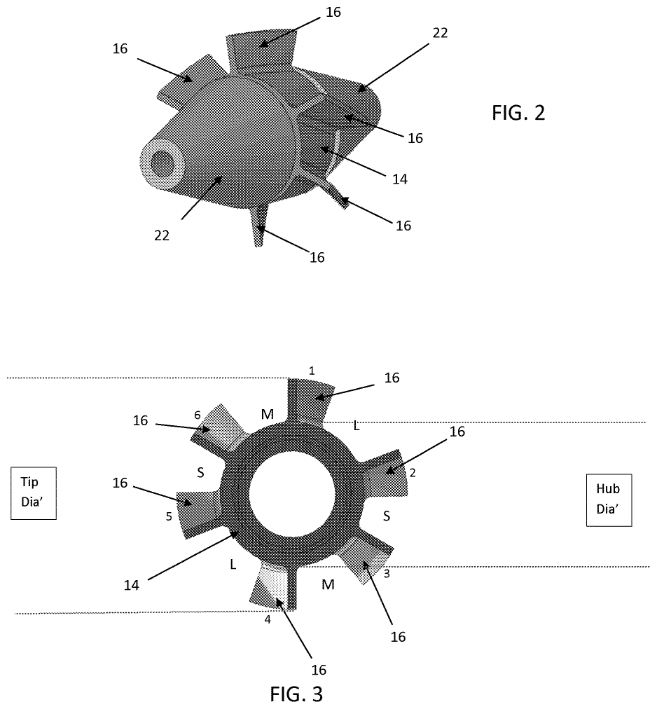

FIG. 2 is a perspective view of the turbine rotor shown in FIG. 1.

FIG. 3 is an end sectional view of the turbine rotor shown in FIG. 1.

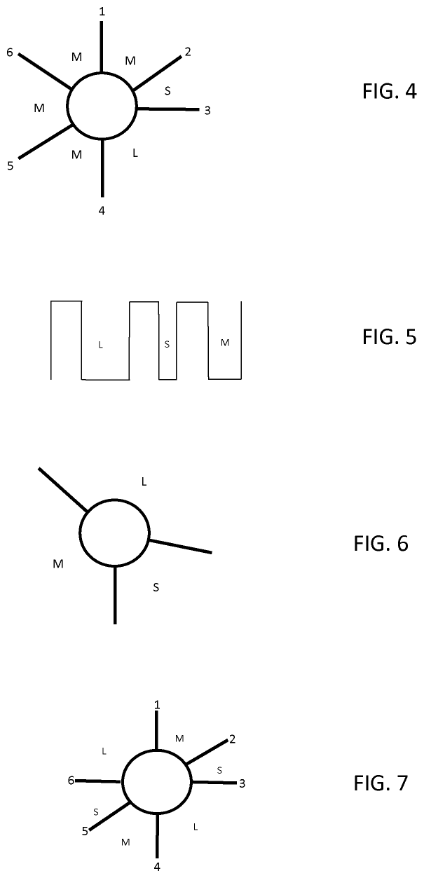

FIG. 4 is a schematic illustration of the position of the turbine blades of the turbine rotor shown in FIG. 3.

FIG. 5 is a schematic representation of the pulse train that would be generated by rotation of a turbine rotor according to the present invention.

FIG. 6 is a schematic illustration of the position of the turbine blades in another example of a turbine rotor for use in the present invention.

FIG. 7 is a schematic illustration of the position of the turbine blades in another example of a turbine rotor for use in the present invention.

Turning to the figures, FIG. 1 is a side view of a flow meter 10 according to the present invention, located within a line, the wall 20 of which is shown as semi-transparent. The flow meter comprises a spindle 12 mounted onto which is a rotatable turbine rotor 14 that comprises six equally spaced turbine blades 16 made from ferrous steel and two conical flow directors 22. The spindle 12 is mounted within the line by two spacers 18.

Screwed through the wall 20 is a transducer housing 24 for a transducer 26, the location of which establishes a detecting position, which in this case is at the top position above the spindle in the wall 20. In use, a fluid, typically a liquid, flows along the line, is redirected by flow directors 22 towards the turbine blades 16, the impingement onto which causes rotation of the turbine rotor 14 around the spindle 12. The presence of the turbine blades 16 are detected by the transducer 26 as they pass during their rotation. The flow rate can then be determined by performing a computation of the measured data.

FIG. 2 shows a perspective view of the turbine rotor 14 and conical flow directors 22 shown in FIG. 1. FIG. 3 shows the turbine rotor 14 with its turbine blades 16 in an end sectional view. The turbine blades have been numbered 1 to 6 and it can be seen that the turbine blades unevenly spaced according to the present invention (S=small, M=medium, L=large spacing).

FIG. 4 shows a schematic illustration of the turbine blades of the turbine rotor shown in FIG. 3, showing more clearly their relative spacings. The spacing between turbine blades 1 and 2 is a first spacing (M). The spacing between turbine blades 2 and 3 is a second spacing(S), measurably smaller than the first spacing. The spacing between turbine blades 3 and 4 is a third spacing (L), measurably larger than.

FIG. 5 shows a schematic representation of the pulse train that would be generated by rotation of the turbine rotor shown according to the invention. In one direction the pulse train corresponds to L-S-M (i.e. the turbine rotor is moving clockwise as shown in FIG. 4), in the reverse direction this becomes M-S-L (i.e. the turbine rotor is moving anticlockwise as shown in FIG. 4). Thus the relative sequence of the variable spacing in the pulse train allows the direction of flow to be determined.

FIG. 6 shows a schematic representation of a further example of the position of the turbine blades in another example of a turbine rotor for use in the present invention.

FIG. 7 shows a schematic representation of a further highly preferred example of the position of the turbine blades of a turbine rotor for use in the present invention. In this case each turbine blade has a directly opposing turbine blade positioned 180° apart. It has six angular spacings, being two first angular spacings (M), two second angular spacings(S) and two third angular spacings (L). Such an arrangement provides balance and a clear signal indicating the sense of rotation of the turbine.

1. An in-line fluid flow meter for measuring the flow rate and direction of fluid flowing in a line, comprising (a) a spindle, mounted onto which is (b) a rotatable rotor comprising at least three vanes or protrusions such that impingement thereon by a flowing fluid in the line causes rotation of the rotor around the spindle, (c) a detector, arranged to detect the presence of the vanes or protrusions as they pass a detecting position, during the rotation of the rotor on the spindle, wherein the angular spacing between two adjacent vanes or protrusions has a first angular spacing, the angular spacing between another two adjacent vanes or protrusions having a second spacing which is measurably different to the first spacing, and wherein the angular spacing between another two adjacent vanes or protrusions have a third spacing which is measurably different to both the first spacing and the second spacing.

2. An in-line fluid flow meter according to claim 1, which is a turbine flow meter wherein the vanes or protrusions are turbine blades.

3. A flow meter according to claim 1, wherein the angular spacings are all within the range of from 150° to 20°.

4. A flow meter according to claim 2, wherein the angular spacings are all within the range of from 100° to 30°.

5. A flow meter according to claim 1, wherein the difference between the maximum angular spacing and the minimum angular spacing is less than 40°.

6. A flow meter according to claim 4, wherein the difference between the maximum angular spacing and the minimum angular spacing is less than 20°.

7. A flow meter according to claim 5, wherein the difference between the maximum angular spacing and the minimum angular spacing is less than 10°.

8. A flow meter according to claim 1, which comprises a single detector and only one detecting position.

9. A flow meter according to claim 1, wherein the meter is a turbine flow meter and the turbine clearance is greater than 10%.

10. A flow meter according to claim 1, wherein the meter is a turbine flow meter and the hub-to-turbine tip ratio is from 0.5 to 0.6.

11. A flow meter according to claim 1, wherein the rotor comprises at least four vanes or protrusions.

12. A flow meter according to claim 11, wherein the rotor comprises from five to ten vanes or protrusions.

13. A flow meter according to claim 11, wherein the additional angular spacings are the same as the first, second and/or third angular spacings.

14. A flow meter according to claim 11, wherein each vane or protrusion is positioned to have a directly opposing vane or protrusion positioned 180° apart.

15. A flow meter according to claim 11, which comprises a vane or protrusion arrangement where the angular spacings include at least two first angular spacings, at least two second angular spacings and at least two third angular spacings.
